(19) United States
(12) Patent Application Publication
(10) Pub. No.: US 2017/0242613 A1
(43) Pub. Date: Aug. 24, 2017

(54) Processing Circuit Controlled Data Storage Unit Selection

(71) Applicant: Seagate Technology LLC, Cupertino, CA (US)

(72) Inventors: John W. Shaw, II, Frederick, CO (US); Robert J. Dore, JR., Thornton, CO (US); Philip Jurey, Longmont, CO (US)

(21) Appl. No.: 15/051,848

(22) Filed: Feb. 24, 2016

(51) Int. Cl. G06F 3/06

(52) U.S. Cl. CPC G06F 3/0635; G06F 3/0611; G06F 3/0688

(57) ABSTRACT

Apparatus and method for managing data in a multi-device data storage system. In some embodiments, a control board interconnects a plurality of storage devices and supports at least first and second switch circuits each operationally connected to the respective storage devices. A storage device control circuit directs user data from a host device to the first switch circuit and control data to the second switch circuit. A peripheral interface control (PIC) circuit selectively establishes an active session, via the first and second switch circuits, between the storage device control circuit and a selected storage device responsive to a command received from the host device associated with the selected storage device.

### SUMMARY

Various embodiments of the present disclosure are generally directed to a multi-device storage system that uses consolidated data channel and control circuitry, such as for use in a cloud computing environment.

In some embodiments, a control board interconnects a plurality of storage devices and supports at least first and second switch circuits each operationally connected to the respective storage devices. A storage device control circuit directs user data from a host device to the first switch circuit and control data to the second switch circuit. A peripheral interface control (PIC) circuit selectively establishes an active session, via the first and second switch circuits, between the storage device control circuit and a selected storage device responsive to a command received from the host device associated with the selected storage device.

In further embodiments, a multi-device storage enclosure has a housing and a control board disposed within the housing. The control board supports a plurality of storage devices, first and second switch circuits each operationally connected to the storage devices, a storage device control circuit configured to direct user data from a host device to the first switch circuit and control data to the second switch circuit, and a peripheral interface control (PIC) circuit configured to selectively establish an active session, via the first and second switch circuits, between the storage device control circuit and a selected storage device of the plurality of storage devices responsive to a command received from the host device associated with the selected storage device.

In still further embodiments, a method includes steps of coupling a plurality of storage devices to a main control board, each of the storage devices comprising a device memory, the main control board comprising first and second switch circuits coupled to the storage devices, a storage device control circuit, a peripheral interface control (PIC) circuit, a local memory and a plurality of firmware stores comprising memory devices each storing firmware respectively executable by the storage device control circuit; receiving a host command to transfer data between a first storage device of said plurality and a host device; using the PIC circuit to load the firmware associated with the first storage device to the local memory from a first firmware store associated with the first storage device and to interconnect, via the first and second switch circuits, the storage device control circuit to the first storage device; and using the storage device control circuit to transfer user data and control data to the first storage device via the first and second switch circuits to service the host command through execution of the firmware loaded from the first firmware store.

These and other features and aspects of various embodiments of the present disclosure can be understood upon a review of the following detailed description in conjunction with the associated drawings.

### BRIEF DESCRIPTION OF THE DRAWINGS

FIG. 1 is a block diagram for a data storage device accordance with some embodiments.

FIG. 2 is an isometric depiction of a data storage unit in the form of a head disc assembly (HDA) constructed and operated in accordance with various embodiments.

FIG. 3 shows aspects of a distributed data storage system that uses HDAs as shown in FIG. 2 in accordance with some embodiments.

FIG. 4 shows an arrangement of the control board and HDAs from FIG. 3 in some embodiments.

FIG. 5 shows aspects of the RF switch from FIG. 4.

FIG. 6 shows aspects of a local preamp from FIG. 5.

FIG. 7 shows aspects of the RF switch and local preamp from FIGS. 4-6 in some embodiments.

FIG. 8 illustrates an input/output (I/O) data flow using the arrangement of FIG. 4 in accordance with some embodiments.

FIG. 9 illustrates operation of a servo control circuit using the arrangement of FIG. 4 in accordance with some embodiments.

FIG. 10 illustrates operation of a spindle control circuit using the arrangement of FIG. 4 in accordance with some embodiments.

FIG. 11 is a functional block representation of the PIC processor from FIG. 4 in accordance with some embodiments.

FIG. 12 is a system operation routine illustrative of steps carried out by the arrangement of FIG. 4 in accordance with some embodiments.

FIG. 13 shows the control board of FIGS. 3-4 in accordance with some embodiments.

FIG. 14 is a functional representation of a networked mass storage system to illustrate a suitable operational environment for various embodiments of the present disclosure.

FIG. 15 is a top plan representation of a multi-device storage enclosure from FIG. 14 using the control board as exemplified in FIG. 13.

### DETAILED DESCRIPTION

The present disclosure generally relates to multi-device data storage systems, and more particularly to a multi-device storage system having consolidated data channel and control circuitry.

Multi-device storage systems employ multiple data storage devices which are operationally arranged to provide a high data capacity memory storage space. The devices are grouped together into a mass storage assembly (MSA) or other module that may be removably installed into a rack system (e.g., a server cabinet).

Multi-device storage systems can take a variety of forms including servers, cloud storage modules, RAID (redundant array of independent discs) systems, extended memory systems (JBODs, or “just a box of drives”), etc. The storage systems can be accessed locally or over a network including a local area network (LAN), a wide area network (WAN), the Internet, etc. A storage enclosure can include various active elements such as storage devices, control boards, power supplies, fans, boot devices, etc.

While operable to provide highly efficient computer storage, multi-device storage systems can be relatively expensive to procure and operate. A significant portion of the overall cost of a multi-device storage system is often attributable to the individual storage devices, which are often stand-alone devices suitable for individual use in separate computing environments. In turn, a significant cost item associated with the devices is the device control circuitry used to facilitate independent operation of each of the devices.

Accordingly, various embodiments are generally directed to a method and apparatus for managing data in a multi-device storage system. As explained below, multiple storage devices are provided to form an overall memory storage space. Each of the devices includes a memory and control elements adapted to perform data transfer operations with the memory.

The devices are coupled to a main control board that supports control circuitry for each of the respective devices. The main control board incorporates various control circuits including a main device controller such as a system on chip (SOC) control circuit, an interface and selection controller such as a peripheral interface controller (PIC) microprocessor, memory, selection circuits and power circuits.

The control board provides the main electronics circuits required by each of the local devices (e.g., HDAs) to operate to transfer data between the memory of the local device and a host device. In some embodiments, one or more storage system modules made up of a control board and associated local devices are in turn provided in a storage enclosure of a distributed data storage system.

In this way, a low cost, high performance multi-device solution, such as a cloud computing network application, is provided in which a single set of electronics is used to control a population of local storage devices. By consolidating certain functions on an external control board such as read/write channel circuitry, data buffers, control logic, servo control, etc., lower cost “dummy storage devices” can be operated in tandem. The dummy storage devices will not necessarily be stand-alone devices capable of operating individually in a separate computing environment, but will have sufficient native electronics to be able to operate with the external data channel supplied by the external control board.

In some cases, the devices are individually operated one at a time” to provide a low cost cold storage solution. In this scenario, the control board switches from one device to the next, powering each one up in turn as needed so that only one of the devices is active and the remaining devices are inactive. It is contemplated, however, that in other embodiments multiple sets of the devices may operate concurrently.

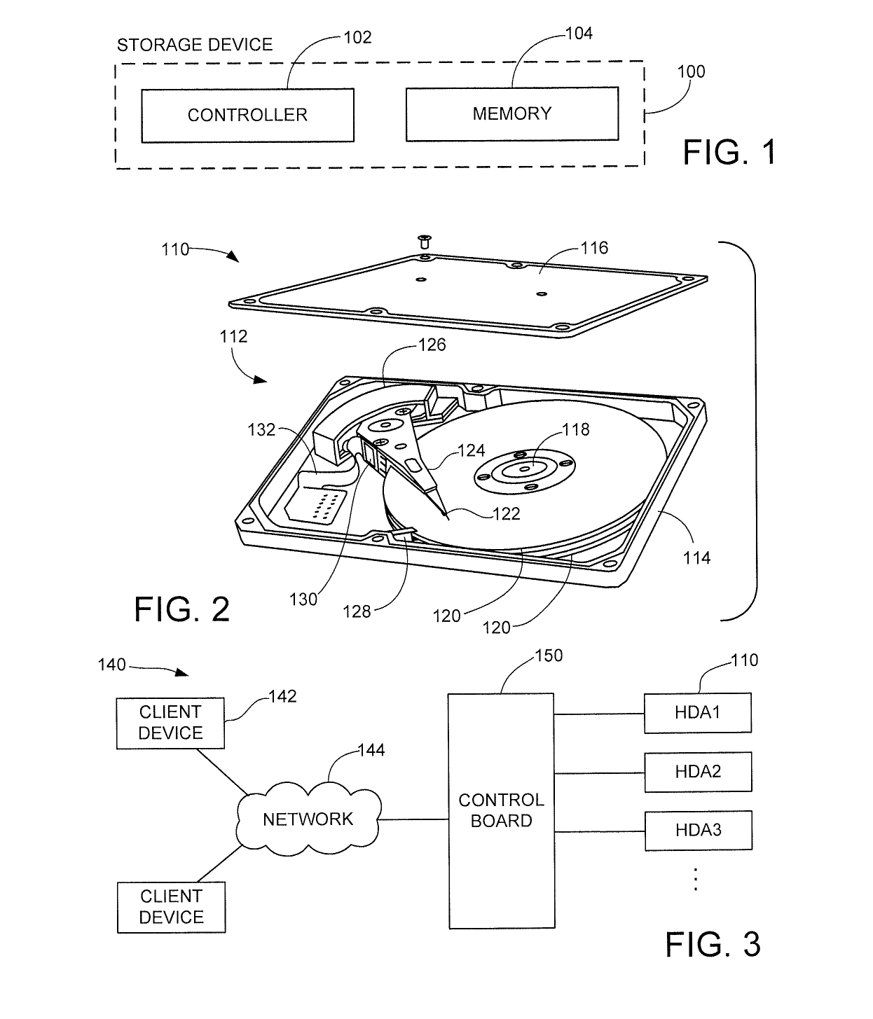

These and other features and advantages of various embodiments can be understood beginning with a review of FIG. 1 which shows an exemplary data storage device 100. The data storage device 100 includes a controller 102 and a memory 104. The controller 102 is a control circuit that provides top level control functionality for the storage device, and may be realized in hardware, software and/or firmware. The memory 104 provides non-volatile memory storage for user data transferred to the storage device by a host device. The memory may incorporate a number of different types of non-volatile storage such as solid-state memory (e.g., flash), rotatable storage media, etc.

The storage device 100 may be a stand-alone device capable of independent operation when interfacing with a host device, or may be a consolidated function (e.g., “dummy”) device that has some native capability but relies on some amount of external consolidated circuitry in order to carry out data transfer functions with a host. It will be noted that, except as discussed below, the overall circuitry of a stand-alone device and a consolidated function device is largely the same; one difference is the extent to which such circuitry is incorporated into the device instead of being physically located external to the device. Another difference is the extent to which the external circuitry is multiplexed among multiple storage devices in a multi-device environment.

FIG. 2 shows aspects of the storage device 100 of FIG. 1 in accordance with some embodiments. A head disc assembly (HDA) 110 generally corresponds to the memory 104 in FIG. 1 and can be arranged to have a sealed housing 112 formed from a rigid base deck 114 and top cover 116.

A spindle motor 118 is supported within the housing 112 to rotate one or more data storage discs 120. It is contemplated that the discs 120 are perpendicular magnetic data recording discs, although other forms of storage media can be used. A total of two (2) discs 120 are shown, although other numbers of discs can be incorporated into the HDA as required.

A corresponding array of data read/write transducers (heads) 122 are supported adjacent the respective data recording surfaces of the discs 120 by a rotary actuator 124. A total of four (4) heads 122 are contemplated as being supported against the four respective surfaces of the two discs, although other configurations can be used. The heads 122 are radially advanced across the corresponding disc surfaces using an actuator motor characterized as a voice coil motor (VCM) 126.

During high speed rotation of the discs 120, the heads 122 are hydrodynamically supported in proximity thereto by fluidic (e.g., air) currents established by the discs. A ramp load/unload feature 128 can be used to unload (park) the heads 122 at a safe position away from the disc surfaces when the HDA 110 is in a deactivated state.

A preamplifier/driver (preamp) circuit 130 can be mounted to a side of the actuator 124 as shown to provide signal processing for the heads in a manner discussed below. A flex circuit assembly 132 provides data and control signal paths to support operation of the heads 122, VCM 126 and preamp 130.

At this point it will be appreciated that the HDA 110 of FIG. 2 can be utilized as part of a hard disc drive (HDD) or other form of data storage device through the mating of the base deck 114 to a corresponding control printed circuit board (PCB or board). FIG. 3 is a functional block representation of a distributed data storage system 140 that can incorporate a number of HDAs 110 from FIG. 2 to provide distributed storage such as in the context of a cloud computing environment. A number of client (host) devices 142 can access the HDAs 110 to store data thereto or retrieve data therefrom via a network 144. The network can take any number of suitable forms, including a local area network (LAN), a wide area network (WAN), a wireless network, an Ethernet network, the Internet, or a combination of the above. While use of network communications is shown, such is not necessarily required.

A main control board 150 is shown in FIG. 3 to direct access commands and input/output (I/O) data between the client devices 142 and the HDAs 110. As discussed below, the control board 150 incorporates certain consolidated processing and switching circuitry to facilitate operation of the respective HDAs as required.

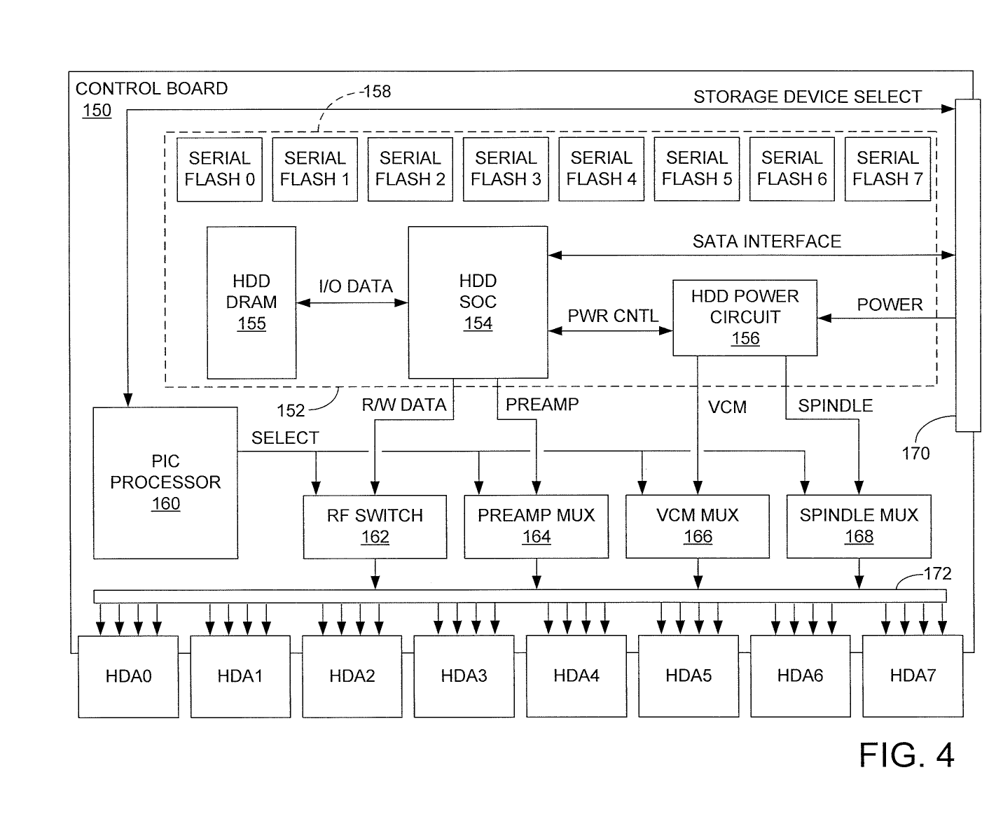

FIG. 4 is a functional block representation of the control board 150 and HDAs 110 from FIG. 3 in accordance with some embodiments. In the example of FIG. 4, a total of eight (8) HDAs 110 (denoted HDA0 to HDA7) are supported by the control board 150. Other numbers of HDAs, including greater or smaller numbers of HDAs, can be utilized as desired.

The control board 150 includes a consolidated HDD circuit portion generally denoted within dotted box 152. Generally, the consolidated circuit 152 operates to supply the control electronics necessary to operate each of the HDAs 110 in turn. The circuit 152 includes a hard disc drive system on chip (HDD SOC) control circuit 154, memory (HDD DRAM) 155, power control circuitry (HDD power circuit) 156 and local memory devices (serial flash 0-7) 158. Other elements may be incorporated into the consolidated circuit 152 as required.

The HDD SOC 154 provides top level control for the respective HDAs 110 and, as shown, incorporates a programmable processing core that utilizes HDA programming instructions (firmware, FW) stored in the various memory devices 158. While a single set of firmware can be utilized, it is contemplated that the activation of each of the respective HDAs 0-7 is carried out by separately loading the firmware from the respective flash device to local memory (HDD DRAM) 155. This has been found to present a number of advantages including the ability to store parameters, control data, state information, etc. associated with each of the HDAs. Moreover, warm boots can be effected by loading appropriate parameters, thereby enhancing the resumption of a given HDA to an operative state.

The control board 150 further incorporates a separate interface control circuit (PIC processor) 160. The PIC processor 160 is a programmable microcontroller that utilizes internal programming stored in internal memory (not separately shown) to carry out various storage device (HDA) selection operations as explained below. The PIC processor 160 provides selection inputs to various switching circuits including an RF switch 162, a preamp multiplexor (mux) 164, a VCM mux 166 and a spindle motor mux 168.

The HDD SOC 154 and the PIC processor 160 each communicate with an external control circuit, such as a host, local server, etc. via an interface connector 170. It is contemplated for purposes of the present discussion that the interface connector 170 supports SATA (serial advanced technology attachment) interface communications, although such is merely exemplary and is not required. Although not expressly shown in FIG. 4, data link communications can be carried out between the HDD SOC 154 and the PIC processor 160 as required.

As will be discussed more fully below, at this point it will be noted that during operation, the PIC processor 160 receives a data access command via the SATA interface to carry out a data transfer operation (e.g.., a write or read command). The command may be in the form of a logical address (such as a logical block address, LBA). The PIC processor operates to identify the associated HDA 110 as well as other addressing information (e.g., head, cylinder, sector, etc.) using suitable data structures. Alternatively, such processing is carried out by the HDD SOC 154 in response to command forwarding from the PIC processor 160.

The PIC processor 160 thereafter enacts various select lines to connect the consolidated HDD circuit 152 to the appropriate HDA. Read/write (R/W) data is directed using the RF switch 162, preamp control and other data are directed using the preamp mux 164, VCM control signals are passed via the VCM mux 166 and spindle motor commutation control signals are passed via the spindle mux 168. Any suitable switching network can be used to pass the requisite signals to the associated HDA 110. For reference, individual signal paths are routed from each of the switching circuits 162, 164, 166 and 168 to the respective HDAs 0-7, as indicated by generalized bus structure 172.

FIG. 5 is a functional block representation of aspects of the arrangement of FIG. 4 in accordance with some embodiments to provide further details regarding operation of the RF switch 162. As shown in FIG. 5, the RF switch 162 is characterized as a main preamp which communicates with (in this case) two local preamps 130 (see FIG. 2) for two of the HDAs 110. The local preamps 130, also referred to as secondary preamps, may be nominally identical to each other, and may further be nominally identical to the main preamp (RF switch) 162 located on the control board 150. In other embodiments, the main preamp 162 may be a different form or style as compared to the local preamps 130.

For clarity of illustration, the main preamp 162 is shown to receive a number of input signals generated by or passed through the control board including write data, read/write (R/W) enable and HDA selection signals. Output read data from the main preamp 162 is also processed by the control board. Other control configurations can be used as desired.

During a write operation, input write data signals are supplied to the main preamp 162 in a suitable extended frequency modulated (EFM) format such as differential PECL digital data signals, and the signals are routed through the main preamp to the appropriate preamp 130.

During a read operation, differential PECL digital readback data signals are transduced and passed from the respective preamps 130 to the main preamp 160. In some embodiments, the main preamp 160 has the capability of selecting and buffering data at frequencies of several Gigahertz, GHz (10¹² clocks/sec) or higher with low distortion. Thus, instead of using the main preamp 162 as a device local preamp, the preamp is repurposed as a high speed data multiplexer (e.g. RF switch) so that the write data are passed through the main preamp 162 and directed to a selected one of the local preamps 160.

The existing head selection functions of the main preamp 162 may be used to select The individual HDAs. Separate head selection and enable signals may be passed from the preamp mux 164 (FIG. 4) to the respective local preamps 130 to provide local control inputs at the local preamp end.

FIG. 6 illustrates operation of a selected local preamp 130 from FIG. 3. The preamp 130 communicates over a number of parallel pathways (R/W H1 through H4) with respective data read/write transducers (heads) 122 (heads 1 through 4) adjacent data recording surfaces of a pair of data recording media (discs) 120 (see FIG. 2).

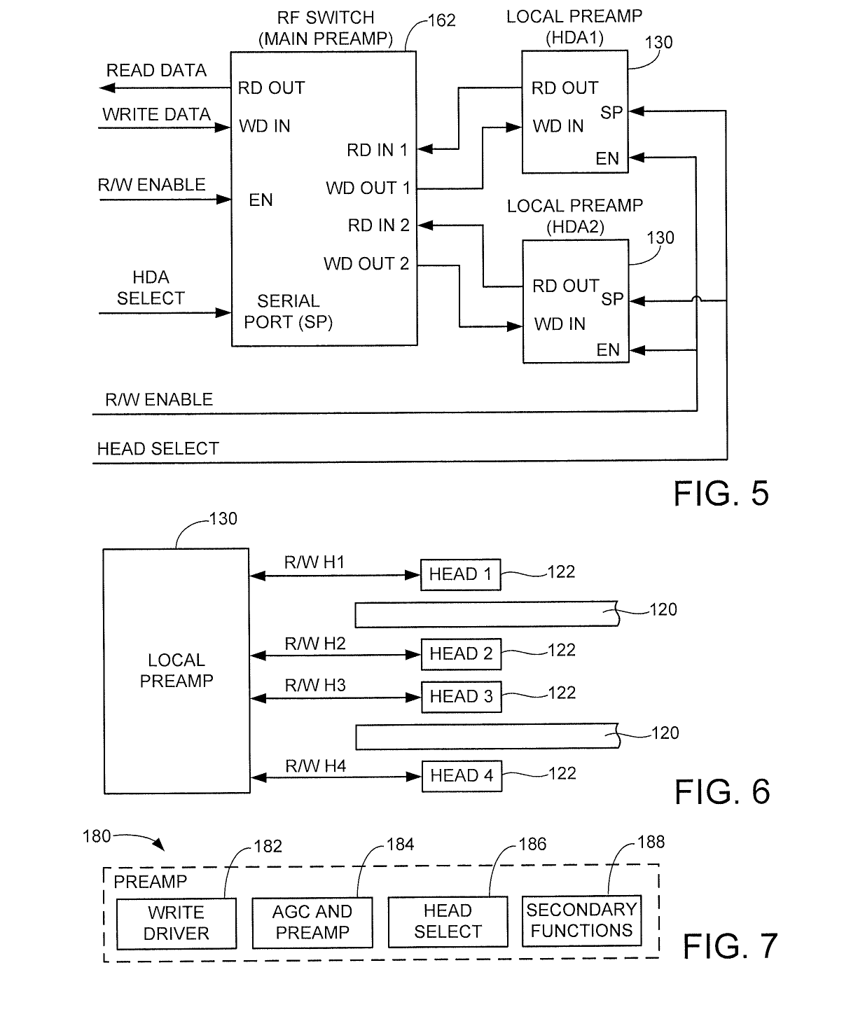

FIG. 7 provides a diagram for a generalized preamp 180 that can be utilized as the aforementioned preamps 130 and/or 162 as required. The preamp 180 includes a write driver 182 for use during the transfer of write data, automatic gain control (AGC) and preamplification (preamp) circuitry 184 for use during the transfer of read data, and head selection logic 186 which can be used to select individual heads (at the storage device level) or to select individual storage devices (at the PC board level). Various secondary functions can be carried out via module 188, such as fly height adjustment, sensor management, laser power control in a heat assisted magnetic recording (HAMR) environment, etc.

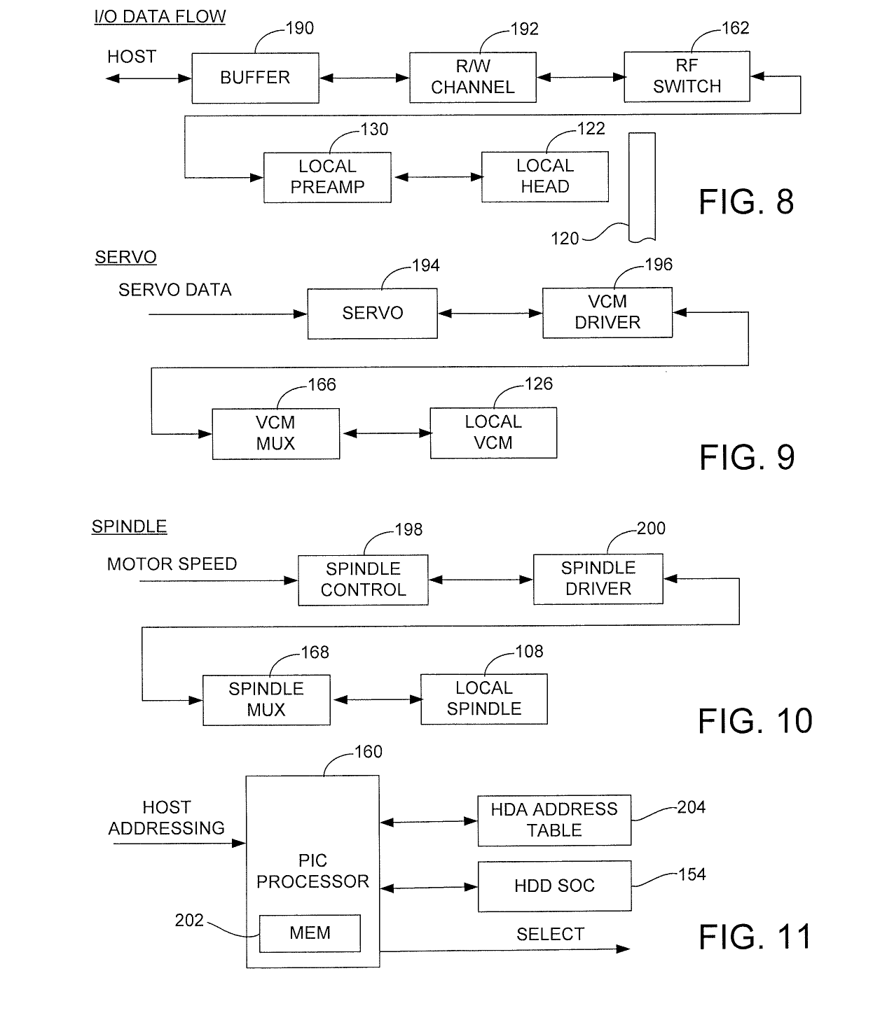

FIG. 8 is a functional diagram for an exemplary I/O data flow carried out by the control board 150 in some embodiments. Write data from an upstream source (host) pass to a data buffer 190 pending writing to the associated HDA. The buffer 190 may be incorporated, for example, into the HDD DRAM 155 (FIG. 4) or other suitable memory location. A read/write (R/W) channel circuit 192 processes the write data by applying suitable encoding to generate the aforementioned frequency modulated data signal which is routed, via the RF switch 162 and local preamp 130, to the associated local head 122 to write the data to the associated medium 120. It is contemplated that the R/W channel circuit may be incorporated into, or operate in conjunction with, the HDD SOC 154. The HDD SOC carries out normal device controller functions such as command queuing, scheduling, etc. to initiate the streaming of the write data to the appropriate head.

During a read operation in which previously written data are recovered from the selected HDA, the HDD SOC 154 schedules the read operation. Upon execution, the local head 122 recovers readback signals from the associated medium 120 which are processed by the local preamp (e.g., amplification, signal normalization, etc.). The preamp signals are passed to the RF switch 162 which may add further preamplification and signal processing to the signals as required. A readback portion of the channel 192 reconstructs the readback signals and may apply error detection and correction techniques as known in the art to provide a final set of readback data. The readback data are placed in the buffer memory 190 pending subsequent transfer to the host via control of the HDD SOC 154 or PIC processor 160, as required.

FIG. 9 is a flow diagram for servo control operations carried out by the control board 150. Demodulated servo data from the respective disc surfaces are forwarded to a servo control circuit 194, which operates to provide a position command signal to a VCM driver circuit 196. The servo control circuit 194 may form a portion of the HDD SOC 154 and the write driver circuit 196 may form a portion of the power circuit 158 (see FIG. 4).

The write driver circuit 196 outputs a control current with polarity and magnitude sufficient to adjust the position of the associated head 122 via the VCM 126. This control current is passed to the appropriate VCM 126 via the VCM mux 166 (FIG. 4). It will be noted that the VCM mux and associated lead lines should be configured to facilitate efficient transfer of the command current. Enhanced traces and power handling circuitry may be utilized.

FIG. 10 is a spindle motor control diagram. Motor speed inputs are supplied to a spindle control circuit 198, which in turn provide commutation signals to a spindle driver circuit 200. As before, the spindle control circuit 198 may be incorporated into the HDD SOC 154 or the power circuit 158. The spindle mux 168 (FIG. 4) directs the currents generated by the spindle driver circuit to the appropriate local spindle motor 108.

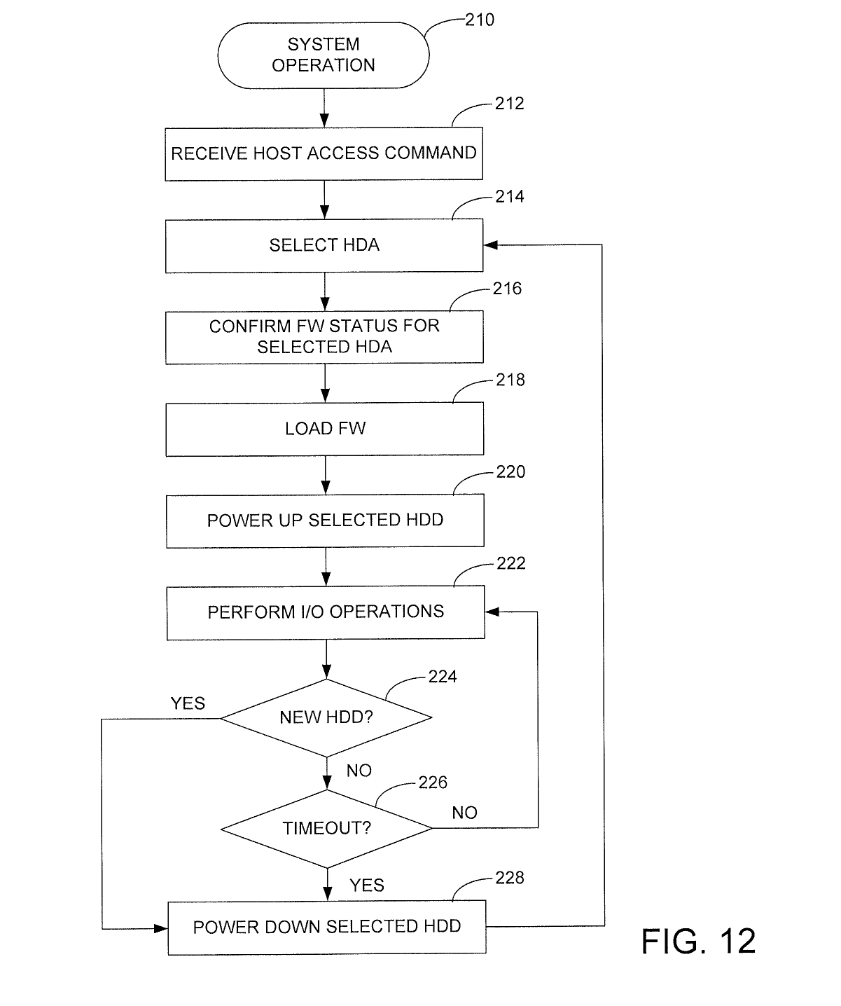

FIG. 11 shows aspects of the PIC processor 160 in further embodiments. The PIC processor 160 may utilize internal or external memory 202 to process host addressing inputs received via the SATA interface. The PIC processor may access one or more HDA processing tables in associated memory 204 to select the appropriate HDA to satisfy the addressing received from the host. A communication link is also shown to the HDD SOC 154 so that the two respective circuits can coordinate the sequential activation and operation of the respective HDAs.

FIG. 12 is a flow chart for a system operation routine 210, generally illustrative of steps carried out by various embodiments in accordance with the foregoing discussion. It will be appreciated that other operations can be carried out and the various steps shown can be modified, performed in a different order, augmented, etc. depending on the requirements of a given application.

It is contemplated albeit not required that the routine commences at a storage state in which the system is in a standby mode. Power is supplied to the control board 150 so that the various circuits thereof are in an operationally ready state to receive and process commands received over the interface, but the various HDAs 0-7 are in a deactivated (spun-down) mode.

A host access command is received at step 212. This host access command may be a read or write command to transfer data between the host (e.g., client devices 142, FIG. 3) and the appropriate storage media (discs 120) of the HDAs 110. The PIC processor 160 detects and processes the command, resulting in selection of the appropriate HDA 110 associated with the command, step 214.

The selection status of the HDA is forwarded to the HDD SOC 154, which may perform various preliminary steps to prepare the selected HDA for activation. Such steps may include, for example, confirming the FW status for the selected HDA prior to spinning up that HDA, as indicated at step 216 and loading the appropriate FW into local memory, step 218.

The selected HDA is thereafter powered up at step 220. In at least some embodiments, this will resemble a conventional power up sequence applied to an HDD so that various initialization sequences are carried out as required. For example, power is supplied to the spindle motor 108 to obtain operational rotational velocity, the heads are unloaded and placed in an operational ready state, and so on. It will be appreciated that the various power and control signals necessary to place the HDA into an operationally ready state are passed via the various switching circuits 162, 164, 166 and 168 (see FIG. 4).

Thereafter, one or more I/O operations are carried out at step 220 to service the pending command(s). These steps may be carried out as discussed above in FIGS. 5-11. In some cases, multiple pending access operations may be aggregated by the PIC processor 160 and queued up in memory so that all of the pending commands for a first HDA are carried out first before switching to a new HDA.

Decision step 222 indicates an analysis whether a new HDA should be selected, indicative of the presence of other commands for one or more other HDAs having been received. If not, decision step 224 indicates an analysis whether a timeout condition has been achieved. If not, continued operation of the selected HDA takes place.

At such times that either a new HDA is to be selected or a timeout condition has been achieved, the flow passes to step 226 where the existing HDA is powered down. This includes steps that may be taken under normal situations with a standard HDD such as the writing of various state parameters and information to memory (e.g., serial flash), the parking of the heads 122 on the ramp structure 128 (see FIG. 2), and the removal of power from the spindle motor 108 so that the discs 120 come to a stop.

It is contemplated that the timeout condition can be any suitable period of time during which no further host I/O commands are received, thereby enabling the system to return all of the HDAs to a deactivated (e.g., non-rotating) state. A suitable interval might be on the order of from about 500 milliseconds to multiple seconds or more, depending on the requirements of a given application.

It is further contemplated that a small delay interval may be implemented after the powering down of a first HDA and the subsequent powering up of a second HDA. This can provide a number of benefits including assurance of a full system reset, accurate loading of the new FW for the newly selected HDA, and so on.

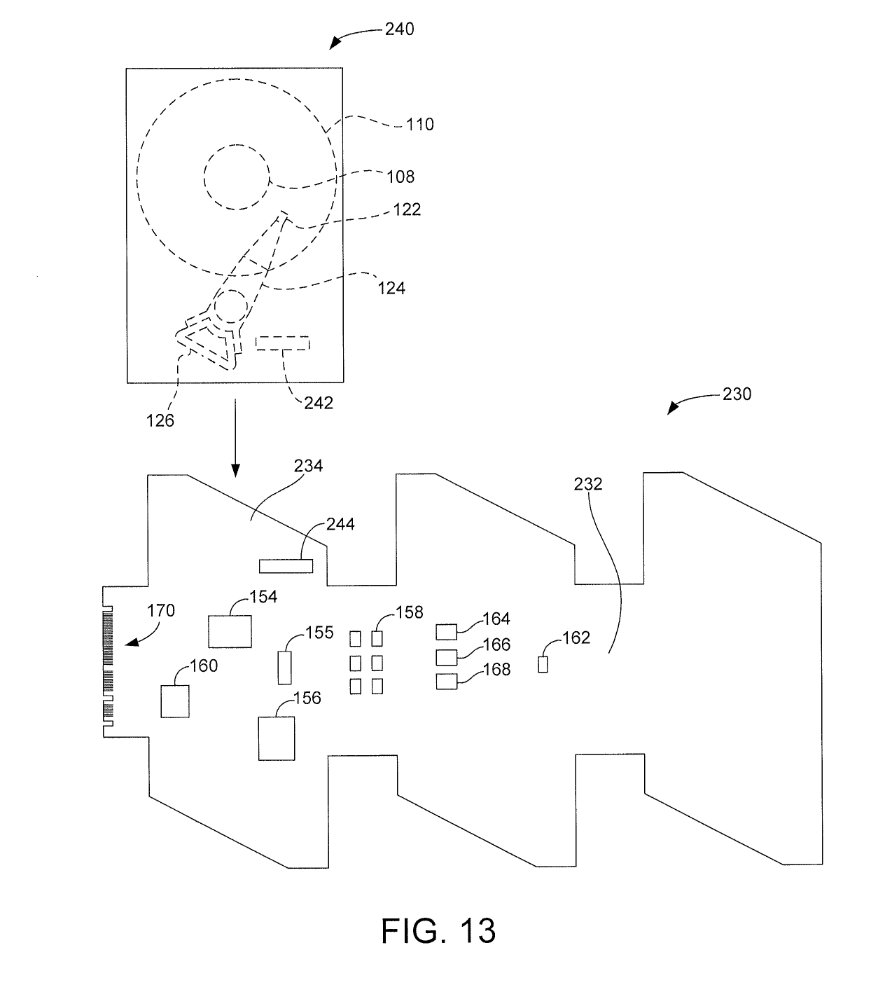

FIG. 13 is a schematic representation of another control board 230 similar to the control board 150 discussed above to illustrate further embodiments of the present disclosure. The control board 220 has a similar configuration as that of board 150 and so like reference numerals will be utilized to denote similar elements. The board 230 is specially configured with a main portion 232 and extensions (tangs) 234. The board 230 is configured to support a total of six (6) HGAs (HGAs 0-5) although other multiple numbers of HGAs can be utilized. The actual sizes and arrangements of the various circuit elements supported by the board 230 will vary so the arrangement shown in FIG. 13 is merely exemplary and is not limiting. It will be understood that additional circuit elements as well as signal paths and other features will be incorporated into the circuit board design.

An exemplary HGA 240 (HGA0) is shown in conjunction with the board 230. It is contemplated that the associated tang 234 is adapted for mating engagement with the HGA 240 so that the HGA is rigidly mounted thereto using suitable hardware (not shown). Communications between the HGA 240 and the board 230 are carried out by respective bulkhead connectors 242, 244 configured to connect the control circuitry on the board 230, via the flex circuit assembly 132 of the HGA (see e.g., FIG. 2), to the various operative elements within the HDA 240.

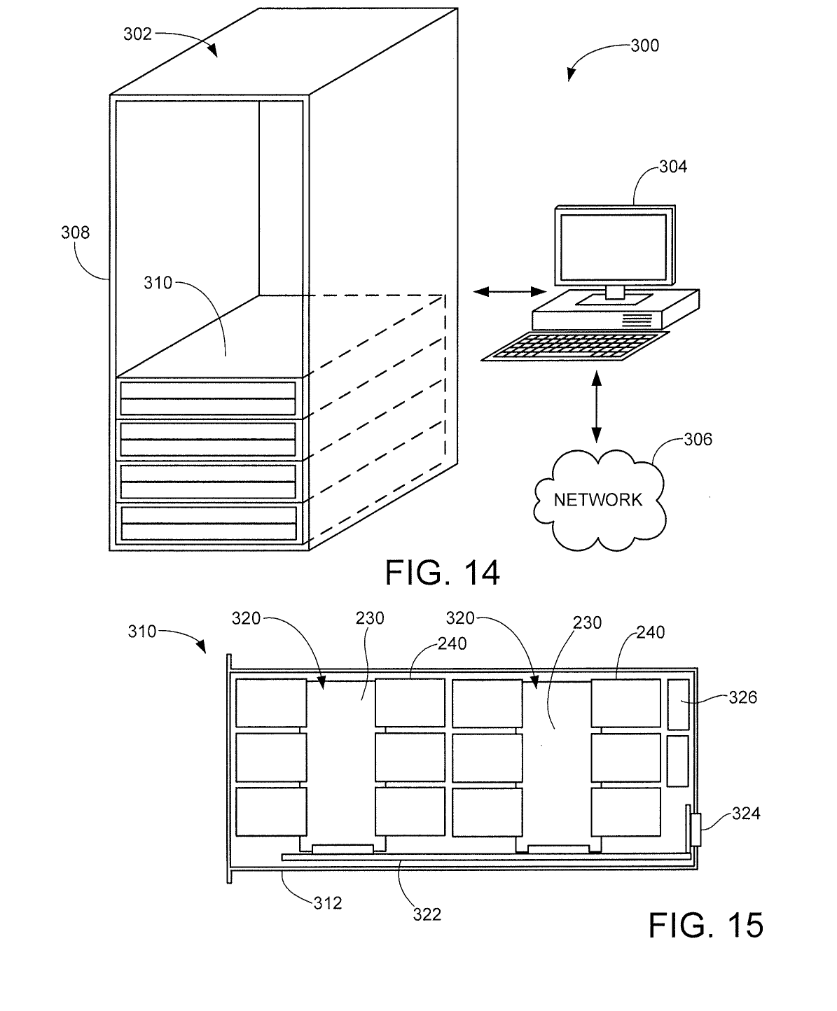

FIG. 14 illustrates a multi-device storage system 300 to depict an exemplary cloud computing environment that can incorporate a fully populated control board and HDA module configuration 230, 240 of FIG. 13 in accordance with the foregoing discussion. The system 300 includes a storage assembly 302 coupled to a computer 304 which in turn is connected to a network 306. The computer 304 can take a variety of forms such as a work station, a local personal computer, a server, etc. The storage assembly 302 includes a server cabinet (rack) 308 and a plurality of modular, multi-device storage enclosures 310.

In some embodiments, the storage rack 308 is a 42U server cabinet with 42 units (U) of storage, with each unit comprising about 1.75 inches (in) of height. The width and length dimensions of the cabinet can vary but common values may be on the order of about 24 in.×36 in. Other sizes can be used. Each storage enclosure can be a multiple of the storage units, such as 2U, 3U, 5U, etc.

An example configuration for a selected storage enclosure 310 is shown in FIG. 15. The storage enclosure 310 has a storage enclosure housing 312 adapted to be supported in the rack 308. Disposed within the housing 312 are two side-by-side storage modules 320 made up of the respective control board 230 and HDAs 240 from FIG. 13. An edge plane connection board 322 can mate with the respective connectors 170 of the boards 230 and provide corresponding interconnections to the rest of the system 300 at a rear of the enclosure housing 312 via enclosure connectors 324. Additional modules can be provisioned within the enclosure housing 312 as well, such as dual redundant power supplies (denoted at 326) and/or other elements such as cooling fans, control circuits, etc.

It will be appreciated that the various embodiments as described herein are well adapted to provide a number of benefits. So called cold-storage solutions can be implemented whereby multiple local storage devices (e.g., HDAs) can be controlled by a main control board with consolidated control circuitry. The various embodiments illustrated above contemplated the powering up of only a single local device (HDA) at a time per board, but such is merely exemplary and is not limiting; in other embodiments, wo or more but less than all of the available local devices can be concurrently operated as desired, provided sufficient redundant circuitry is in place (including multiple controllers, multiple levels of switching circuitry, etc.).

The PIC processor 160 or other control circuit is adapted as described herein to provide efficient processing of the addressing and device switching requirements of the system. Depending on the requirements, the PIC processor can handle substantially all system configuration requirements of the system including the loading of the respective firmware sets, etc. In some embodiments, the HDD SOC 154 can operate as a slave to the master processor 160 so that the HDD SOC is agnostic with regard to which particular HDA is being operated. This can provide a number of benefits including using a standardized design for the HDD level electronics (e.g., portion 152 in FIG. 4) which are then controlled by the top level control circuit 160.

While local storage devices characterized as hard disc drives (HDDs) have been exemplified herein, such is merely exemplary and is not limiting. Other forms of storage devices can be readily incorporated into the system including solid-state drives (SSDs) that use semiconductor non-volatile memory to store user data. While preamplifier/driver circuits have further been exemplified in various embodiments, such is merely exemplary and is not limiting as other types of driver circuits can be implemented as desired.

Finally, while it is contemplated that all of the storage devices attached to a given control board (e.g., 150, 230) will be nominally identical (e.g., all HDAs of a nominally common configuration, storage capacity, number of discs/heads, rotational speed, etc.), such is merely exemplary and is not limiting. In further embodiments, a particular storage module (such as 320 in FIG. 15) can be populated with multiple different types of storage devices, such as HDAs and SSDs, etc., which are operated as required. In still further embodiments, SSDs can be incorporated into the main portion (e.g., 232) of the control board and maintained in a fully operational mode, with the circuitry operating in the back ground to subsequently transfer data received by the SSDs onto the HDAs. These and other alternatives will readily occur to the skilled artisan in view of the present disclosure.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
A control board configured to connect to a plurality of storage devices;
switching circuitry supported by the control board comprising first and second switch circuits each operationally connected to respective storage devices;
a storage device control circuit configured to direct user data from a host device to the first switch circuit and control data to the second switch circuit; and
a peripheral interface control (PIC) circuit configured to selectively establish an active session, via the first and second switch circuits, between the storage device control circuit and a selected storage device responsive to a command received from the host device associated with the selected storage device.

2. The apparatus of claim 1, wherein each of the storage devices comprises a local driver circuit and a memory, and the first and second switch circuits are connected to the local driver circuit of each of the storage devices.

3. The apparatus of claim 1, wherein the PIC circuit identifies the selected one of the storage devices responsive to a logical address associated with the user data from the host device.

4. The apparatus of claim 1, wherein the control board interconnects a total number of N data storage devices coupled to the first and second switch circuits, the control board further supporting a corresponding number N non-volatile solid-state memory devices each storing a corresponding set of firmware executable by the storage device control circuit, wherein the PIC circuit directs a loading of the respective firmware to a local volatile memory associated with the selected one of the plurality of storage devices for execution by the storage device control circuit during the active session.

5. The apparatus of claim 1, wherein the PIC circuit is further configured to, responsive to receipt of a second access command from the host device associated with a second selected storage device, to direct the storage device control circuit to deactivate the selected storage device, the PIC circuit establishing a second active session between the storage device control circuit and the second selected storage device via the first and second switch circuits to service the second access command.

6. The apparatus of claim 1, wherein each of the storage devices comprises a head disc assembly (HDA) of a hard disc drive (HDD) having at least one rotatable data recording medium and a moveable data read/write transducer, and wherein control circuitry utilized by the HDA is consolidated on the control board including the storage device control circuit.

7. The apparatus of claim 1, wherein each of the storage devices is nominally identical.

8. the apparatus of claim 1, wherein a first storage device of the plurality of storage devices is characterized as an HDA having rotatable data recording media and a second storage device of the plurality of storage devices is characterized as a solid state drive (SSD) which utilizes solid-state flash memory.

9. The apparatus of claim 1, wherein the first switch circuit is a radio-frequency (RF) switch and the second switch circuit is a multiplexor.

10. The apparatus of claim 1, wherein the control data passed via the second switch circuit comprises at least a selected one of preamp selection signals for the storage devices, current for voice coil motors (VCMs) of the storage devices, or current for spindle motors of the storage devices.

11. The apparatus of claim 1, wherein the switching circuitry, storage device control circuit and PIC circuit are disposed on the control board to form an integrated storage module.

12. The apparatus of claim 11, wherein a corresponding plurality of serial flash integrated circuit (IC) devices are further supported on the control board each storing a copy of firmware separately executable by the storage device control circuit during a corresponding active session between the storage device control circuit and the associated storage device, wherein the PIC circuit establishes an active session with only a single one of the storage devices at a time.

13. A system, comprising:
a multi device storage enclosure housing;
a control board disposed within the housing and supporting:
a plurality of storage devices;
first and second switch circuits each operationally connected to the storage devices;
a storage device control circuit configured to direct user data from a host to the first switch circuit and control data to the second switch circuit; and
a peripheral interface control (PIC) circuit configured to selectively establish an active session, via the first and second switch circuits, between the storage device control circuit and a selected storage device responsive to a command received from the host associated with the selected storage device.

14. The system of claim 13, further comprising at least one power supply disposed within the housing to supply electrical power to the control board.

15. The system of claim 13, characterized as a cold storage module wherein the PIC circuit establishes communication between the storage device control circuit and only a selected one of the storage devices at a time so that the remaining storage devices are maintained in a powered down state.

16. The system of claim 13, wherein the control board further supports a plurality of individual non-volatile memory devices, each memory device storing a separate copy of firmware executable by the storage device control circuit, wherein the PIC circuit directs a loading of the separate copy of the firmware from each selected memory device in turn to a local memory for execution by the storage device control circuit during a corresponding active session between the storage device control circuit and the associated storage device.

17. A method comprising:
coupling a plurality of storage devices to a main control board, each of the storage devices comprising a device memory, the main control board comprising first and second switch circuits coupled to the storage devices, a storage device control circuit, an interface control circuit, a local memory and a plurality of firmware stores comprising memory devices each storing firmware respectively executable by the storage device control circuit;
receiving a host command to transfer data between a first storage device of said plurality and a host device;
using the interface control circuit to load the firmware associated with the first storage device to the local memory from a first firmware store associated with the first storage device and to interconnect, via the first and second switch circuits, the storage device control circuit to the first storage device; and
using the storage device control circuit to transfer user data and control data to the first storage device via the first and second switch circuits to service the host command through execution of the firmware loaded from the first firmware store.

18. The method of claim 17, further comprising:
using the interface control circuit to instruct the storage device control circuit to deactivate the first storage device, said deactivation including causing a rotatable data storage medium of the first storage device to come to a stop;
waiting a selected delay interval; and
using the interface control circuit to load the firmware associated with a second storage device from a different, second firmware store associated with the second storage device to the local memory in preparation for servicing a second received host command associated with the second device.

19. The method of claim 17, wherein the first switch circuit is a main preamplifier/driver circuit adapted as an RF switch, and wherein the user data are transferred from the main preamplifier/driver circuit to a local preamplifier/driver circuit of the first storage device.

20. The method of claim 17, wherein the interface control circuit interconnects, via the first and second switch circuits, the storage device control circuit to only a selected one of the plurality of storage devices at a time.
